(19) United States
(12) Patent Application Publication
(10) Pub. No.: US 2026/0163159 A1
(43) Pub. Date: Jun. 11, 2026

(54) Battery Module

(71) Applicant: SK On Co., Ltd., Seoul (KR)

(72) Inventors: Soo Hwan JO, Daejeon (KR); Jae In KIM, Daejeon (KR); Jin Kwan KIM, Daejeon (KR); Sung Min HONG, Daejeon (KR)

(21) Appl. No.: 19/308,407

(22) Filed: Aug. 25, 2025

(30) Foreign Application Priority Data
Dec. 9, 2024 (KR) 10-2024-0181644

(51) Int. Cl. H01M 50/262; H01M 10/48; H01M 50/211; H01M 50/503; H01M 50/507

(52) U.S. Cl. CPC H01M 50/262; H01M 10/482; H01M 50/211; H01M 50/503; H01M 50/507

(57) ABSTRACT

A battery module according to an embodiment of the present disclosure includes: a cell stack in which a plurality of battery cells are stacked; a bus bar frame disposed on one side of the cell stack; a bus bar disposed on the bus bar frame and configured to electrically connect each of the plurality of battery cells; and a sensing terminal disposed on the bus bar frame and electrically connected to the bus bar, wherein a terminal restraining part is disposed on a front surface of the bus bar frame, the terminal restraining part protruding forward and supporting at least a partial region of the sensing terminal.

### CROSS-REFERENCE TO RELATED APPLICATION

This patent application claims the priority and benefits of Korean patent application No. 10-2024-0181644, filed on Dec. 9, 2024, the disclosure of which is incorporated herein by reference in its entirety.

### BACKGROUND OF THE INVENTION

### 1. Field of the Invention

The present disclosure relates to a battery module.

### 2. Description of the Related Art

Various types of secondary batteries are used as energy sources in electric vehicles or electronic devices. In the secondary batteries, a jelly-roll-type electrode assembly, in which an anode plate, a cathode plate and a separator are wound together, is used, or alternatively, an electrode assembly fabricated by stacking an anode plate, a cathode plate, and a separator in an appropriate order may be used.

These electrode assemblies constitute a battery cell, and a plurality of battery cells are assembled to form a battery module.

In the battery module, each battery cell is connected through a bus bar, and a sensing unit for obtaining information on each battery cell may be connected to the bus bar.

### SUMMARY OF THE INVENTION

An object of the present disclosure is to provide a battery module capable of preventing failure in a sensing terminal assembly during the manufacture of the battery module.

A battery module according to an embodiment of the present disclosure may include: a cell stack in which a plurality of battery cells are stacked; a bus bar frame disposed on one side of the cell stack; a bus bar disposed on the bus bar frame and configured to electrically connect each of the plurality of battery cells; and a sensing terminal disposed on the bus bar frame and electrically connected to the bus bar, wherein a terminal restraining part may be disposed on a front surface of the bus bar frame, the terminal restraining part protruding forward and supporting at least a partial region of the sensing terminal.

In an embodiment, the terminal restraining part may include a first restraining part disposed to pass through the sensing terminal and restrict a positional movement of the sensing terminal.

In an embodiment, the first restraining part may protrude from the frame body and may be disposed to pass through the sensing terminal in a longitudinal direction of the battery cell.

In an embodiment, the first restraining part may be formed in a cylindrical shape.

In an embodiment, the first restraining part may include a shaft portion extending from the frame body and a head portion formed at an end of the shaft portion, wherein the head portion may have a cross-sectional area that decreases with increasing distance from the frame body.

In an embodiment, the sensing terminal may include a through-hole formed on one side thereof, through which the first restraining part passes.

In an embodiment, the terminal restraining part may include a second restraining part, at least a partial region of which is in contact with a side surface of the sensing terminal to restrict the positional movement of the sensing terminal.

In an embodiment, a pair of second restraining parts may be provided so as to be in contact with opposite sides of the sensing terminal, respectively.

In an embodiment, the second restraining parts may be disposed so that at least a partial region thereof may be in contact with the bus bar.

In an embodiment, each of the pair of second restraining parts may include: a support portion disposed at a first height such that one end thereof is in contact with the side surface of the sensing terminal; a base portion disposed at a second height such that one end thereof is spaced apart from the side surface of the sensing terminal; and a vertical extension portion configured to connect one end of the base portion and the other end of the support portion.

In an embodiment, a gap between the pair of base portions arranged adjacent to each other may be greater than a width of the sensing terminal.

In an embodiment, the first restraining part may be disposed higher than the support portion.

In an embodiment, the base portion may be disposed to be spaced apart from the bus bar by a predetermined distance.

In an embodiment, the first restraining part and the second restraining part may support the sensing terminal at different heights.

In an embodiment, the first restraining part may support the sensing terminal at a position higher than the second restraining part.

In an embodiment, the protrusion length of the first restraining part from the frame body may be greater than that of the second restraining part from the frame body.

In an embodiment, the first restraining part and the second restraining part may protrude from the frame body by a length greater than a thickness of the sensing terminal.

In an embodiment, the sensing terminal may include a bus bar coupling region in which at least a partial region of the sensing terminal overlaps the bus bar, and the terminal restraining part may be disposed to support the sensing terminal in a region excluding the bus bar coupling region.

In an embodiment, the bus bar may include a bus bar slot formed to allow electrode leads of the battery cell to be drawn out, and the first restraining part may be disposed between the bus bar slots arranged adjacent to each other.

In an embodiment, a gap between a pair of the second restraining parts may be formed smaller than a gap between the slots arranged adjacent to each other.

In the battery module according to the various embodiments of the present disclosure, the positional movement of the sensing terminal is restricted by the terminal restraining part, so that the bus bar coupling region of the sensing terminal may be stably formed between adjacent electrode leads.

Therefore, the present disclosure may improve the welding quality between the sensing terminal and the bus bar, and may prevent the sensing terminal from being detached from the bus bar due to a welding defect.

In addition, the battery module of the present disclosure may prevent interference between the sensing terminal and the electrode lead, thereby enabling stable welding between the electrode lead and the bus bar.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view schematically illustrating an assembly structure of a sensing terminal according to an embodiment of the present disclosure;

FIG. 2 is a front view schematically illustrating the assembly structure of the sensing terminal according to an embodiment of the present disclosure;

FIG. 3 is a schematic cross-sectional view taken along line A1-A2 of FIG. 2 according to an embodiment of the present disclosure;

FIG. 4 is a front view schematically illustrating a bus bar frame according to an embodiment of the present disclosure;

FIG. 5 is a cross-sectional view taken along line B1-B2 of FIG. 4;

FIG. 6 is a perspective view schematically illustrating an assembly structure of the sensing terminal according to an embodiment of the present disclosure; and

FIG. 7 is a front view schematically illustrating the assembly structure of the sensing terminal according to an embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe his or her invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and thus should not be interpreted to exclude the presence of other components but rather to include them.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to facilitate understanding of the relationship between an element or feature and another element or feature illustrated in the drawings. These space-related terms are provided to facilitate understanding of the present disclosure in their various process or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” or “below” depending on orientation.

The embodiments described in this specification and the configurations illustrated in the drawings merely represent the most preferred embodiments of the present disclosure but do not encompass all technical spirits of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, battery modules according to various embodiments of the present disclosure will be described in detail with reference to the accompanying drawings.

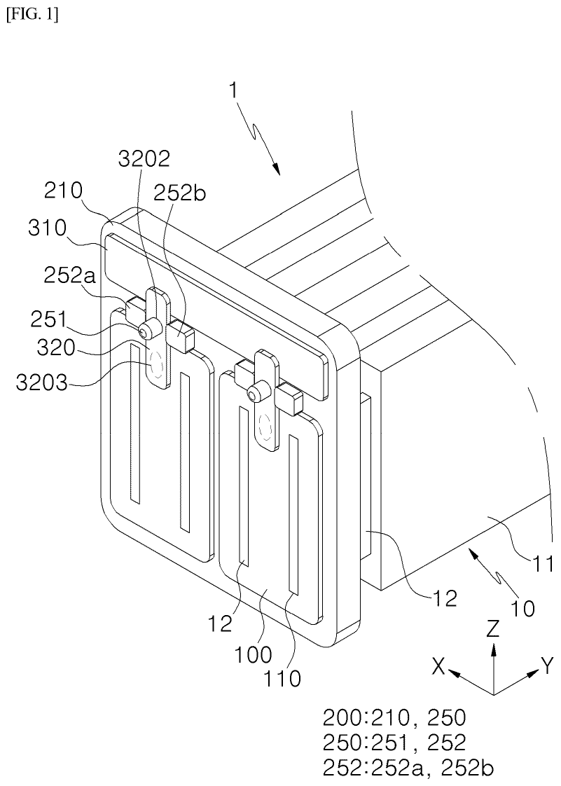

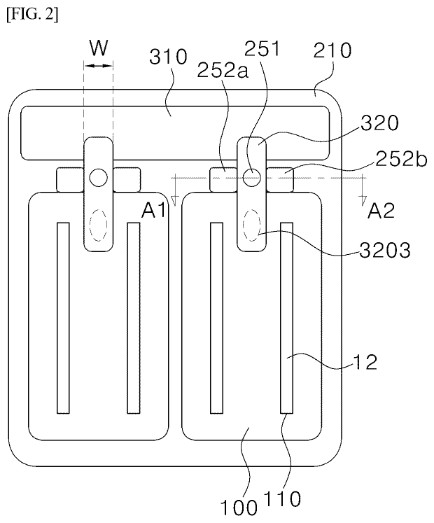

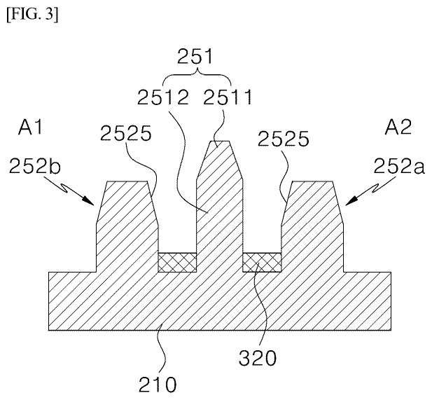

FIG. 1 is a perspective view schematically illustrating an assembly structure of a sensing terminal 320 according to an embodiment of the present disclosure, FIG. 2 is a front view schematically illustrating the assembly structure of the sensing terminal 320 according to an embodiment of the present disclosure, and FIG. 3 is a schematic cross-sectional view taken along line A1-A2 of FIG. 2 according to an embodiment of the present disclosure.

Referring to FIGS. 1 to 3, a battery module according to various embodiments of the present disclosure may include a cell stack 1, a bus bar frame 200, a bus bar 100, and a sensing unit 300.

The cell stack 1 may include a plurality of battery cells 10 that are stacked together. The battery cell 10 may be a pouch-type battery cell 10 in which electrode leads are drawn out of an outer case 11, but it is not limited thereto.

In one embodiment, the battery cell 10 may include an electrode assembly, an electrolyte, and the outer case 11.

The electrode assembly may include a first electrode (not shown), a second electrode (not shown), and a separator (not shown). The first electrode and the second electrode may each be provided in plate shapes. Each of the first electrode and the second electrode may include a current collector and a coating layer on which an active material is coated on the current collector.

The second electrode may be either a cathode or an anode. When the first electrode is an anode, the second electrode may be a cathode, and when the first electrode is a cathode, the second electrode may be an anode.

In one embodiment, the first electrode may be a cathode. The first electrode may include a first current collector (not shown) in the form of a metal foil, and a first coating layer (not shown) formed by applying a cathode active material to the first current collector. For example, the first current collector may be a cathode current collector and may include aluminum.

In one embodiment, the first coating layer may be an electrically conductive coating, and may serve as a cathode coating layer. The first coating layer may include a cathode active material. For example, the cathode active material may include lithium nickel manganese cobalt oxide (NMC), lithium manganese oxide (LMO), lithium iron phosphate (LFP), lithium cobalt oxide (LCO), lithium titanate (LTO), or a chalcogenide compound (such as LiTiS₂). However, it is not limited thereto, and any cathode active material known to those skilled in the art may be used.

The first current collector may include a first uncoated part (not shown) on which no first coating layer is formed. The first uncoated part may be described as a first electrode tab. The first uncoated part may be connected to a first electrode lead. For example, the first uncoated part may be a cathode uncoated part, and may function as a cathode tab.

In one embodiment, the second electrode may be an anode. The second electrode may include a second current collector (not shown) in the form of a metal foil and a second coating layer (not shown) formed by applying an anode active material to the second current collector. For example, the second current collector may be an anode current collector and may include copper or nickel.

In one embodiment, the second coating layer may be an electrically conductive coating, and may serve as an anode coating layer. The second coating layer may include an anode active material. For example, the anode active material may include a silicon material (e.g., metallic silicon and silicon dioxide), a carbon-based material (e.g., graphite materials, graphene-containing materials, hard carbon, soft carbon, carbon nanotubes, porous carbon, or conductive carbon), a tin-based material, or a metal oxide. However, it is not limited thereto, and any anode active material known to those skilled in the art may be used.

The second current collector may include a second uncoated part (not shown) on which no second coating layer is formed. Here, the second uncoated part may be described as a second electrode tab. The second uncoated part may be connected to a second electrode lead. For example, the second uncoated part may be an anode uncoated part, and may function as an anode tab.

The separator may be interposed between the first electrode and the second electrode to prevent the first electrode and the second electrode from being electrically connected to each other and causing a short circuit. In one embodiment, the separator may include an electrically insulating material. For example, the separator may include a polymeric material. For example, the separator may include polyethylene, polypropylene, or a combination thereof, but it is not limited thereto.

The first electrode and the second electrode may be stacked on the separator. The first electrode and the second electrode may be alternately stacked based on the separator to form an electrode assembly. For example, the electrode assembly may be configured so that the separator is folded in a folding structure, but it is not limited thereto.

In one embodiment, the electrode assembly may be inserted into a receiving space formed by the outer case 11 together with an electrolyte. The outer case 11 may serve to mechanically and chemically protect the electrode assembly and the electrolyte accommodated therein, and to electrically insulate the inside and the outside of the outer case 11. For example, the outer case 11 may be formed in a multi-layer structure. The outer case 11 may include an outer polymer layer providing mechanical strength and insulation, an inner polymer layer providing chemical resistance to the electrolyte, and an aluminum thin-film layer interposed between the inner polymer layer and the outer polymer layer to block oxygen and moisture and provide gas impermeability, but it is not limited thereto.

Electrode leads 12 may be disposed on the outer case 11, which are drawn from the inside to the outside of the outer case 11. The electrode lead 12 may include a first electrode lead 12a connected to the first uncoated part of the above-described first electrode and a second electrode lead (not shown) connected to the second uncoated part of the second electrode. The electrode lead 12 may function as an electrode terminal of the battery cell 10.

Here, it may be described that the first electrode lead 12a and the second electrode lead of the electrode lead 12 are disposed at the front and rear of the cell stack 1, respectively. However, this is merely illustrative, and it should be understood that the first electrode lead 12a and the second electrode lead may be disposed on the same side, or may be respectively disposed on opposite sides.

In this embodiment, the outer case 11 may be provided in a generally rectangular parallelepiped shape extending in the longitudinal direction, but it is not limited thereto.

Hereinafter, the electrode lead 12 may be used as a term collectively referring to the first electrode lead 12a and the second electrode lead. Alternatively, the electrode lead 12 may refer to either the first electrode lead 12a or the second electrode lead.

Hereinafter, a direction in which a plurality of battery cells 10 are stacked may be described as the stacking direction, a direction in which the battery cells 10 extend may be described as the longitudinal direction or the front-back direction, and a direction perpendicular to both the stacking direction and the longitudinal direction may be described as the vertical direction.

For example, a direction in which the first electrode lead 12a is drawn out may be described as the front, and a direction in which the second electrode lead is drawn out may be described as the rear.

The battery module may include the bus bar 100. The bus bar 100 may be electrically connected to the cell stack 1. The bus bar 100 may electrically connect each battery cell 10 constituting the cell stack 1. For example, a plurality of bus bars 100 may be provided.

The bus bar 100 may electrically connect each electrode lead of the plurality of battery cells 10. The bus bar 100 may include a bus bar slot 110 formed therein, through which the electrode lead may extend. The bus bar 100 may include the bus bar slot 110 formed to allow the electrode leads 12 of the battery cell 10 to be drawn out. For example, the bus bar 100 may be connected to each electrode lead with the electrode lead passing through the bus bar. For example, the bus bar 100 may be welded to each electrode lead.

The bus bar 100 may be disposed between an outer housing of the battery module and the cell stack 1. The bus bar 100 may be disposed in the direction in which the electrode leads are drawn out from the cell stack 1. For example, when the electrode leads are drawn out to the front and rear of the battery cells 10, respectively, the bus bar 100 may be disposed at the front and rear of the cell stack 1, respectively. The bus bar 100 may be disposed in the bus bar frame 200 and connected to the electrode leads.

Here, for convenience of description, it will be described based on an embodiment in which the bus bar 100 is disposed at the front of the cell stack 1.

The battery module may include the sensing unit 300. The sensing unit 300 may include a sensing connection part, a sensing module 310, and the sensing terminal 320.

The sensing connection part may be disposed at an upper or lower portion of the cell stack 1, and may extend in the longitudinal direction of the battery cell 10. The sensing modules 310 may be connected to both ends of the sensing connection part.

The sensing unit 300 may include the sensing module 310 disposed on the bus bar frame 200, the sensing terminal 320 that connects the sensing module 310 and the bus bar 100, and the sensing connection part that interconnects the sensing modules 310 disposed on opposite sides of the longitudinal direction of the cell stack 1.

The sensing module 310 may be connected to both ends of the sensing connection part, and may be disposed on the bus bar frame 200. For example, the sensing module 310 may be disposed on the front surface of the bus bar frame 200 to extend in the stacking direction.

The sensing module 310 may be seated on the bus bar frame 200 and electrically connected to the bus bar 100 through the sensing terminal 320. The sensing module 310 may obtain information such as voltage, current, temperature, and/or state of charge of the battery cell 10 through the bus bar 100. The sensing module 310 may be formed of a flexible material such as a flexible printed circuit board (FPCB).

The sensing terminal 320 may electrically connect the sensing module 310 and the bus bar 100. The sensing terminal 320 may serve as an electrical path for transmitting the above-described information or electrical signal regarding the battery cell 10 to the sensing module 310.

For example, a plurality of sensing terminals 320 may be disposed to be connected to each of the plurality of bus bars 100. Each of the plurality of sensing terminals 320 may branch from the sensing module 310 toward each of the bus bars 100 and be connected thereto.

The sensing terminal 320 may be disposed on the bus bar frame 200. The sensing terminal 320 may have a predetermined width (e.g., W of FIG. 2), and may be disposed to extend from the sensing module 310 toward the bus bar 100. For example, the sensing terminal 320 may be disposed to extend downward from the sensing module 310.

For example, an upper end of the sensing terminal 320 may be connected to the sensing module 310. For example, the sensing terminal 320 may be welded to the sensing module 310, but it is not limited thereto, and may extend integrally from the sensing module 310. For example, a lower end of the sensing terminal 320 may be connected to the bus bar 100. The sensing terminal 320, like the above-described sensing module 310, may be formed of a flexible material such as a flexible printed circuit board (FPCB), and may be provided in the form of a thin plate-like film.

In one embodiment, the sensing terminal 320 may be supported by a terminal restraining part 250 formed on the bus bar frame 200 to restrict its positional movement. For example, the sensing terminal 320 may include a through-hole 3202 formed on one side thereof, through which a first restraining part 251 described below passes.

The bus bar frame 200 may be disposed between the cell stack 1 and the bus bar 100. For example, the bus bar frame 200 may be disposed on at least one side in the longitudinal direction of the cell stack 1 to support the bus bar 100.

The sensing module 310 and the bus bar 100 are respectively disposed on the front surface of the bus bar frame 200, and the sensing terminal 320 may be disposed to connect the sensing module 310 and the bus bar 100.

During the manufacturing process of the battery module, while one end of the sensing terminal 320 is connected to the sensing module 310, the other end may be joined to the bus bar 100 by welding or the like.

However, as described above, since the sensing terminal 320 is provided in the form of a thin film made of a flexible material such as FPCB, there has been difficulty in restricting the position of the sensing terminal 320 when the other end of the sensing terminal 320 was joined to the bus bar 100.

If the sensing terminal 320 is welded to the bus bar 100 while being misaligned, the welding quality may deteriorate, and if the sensing terminal 320 is separated from the bus bar 100 due to the deterioration in welding quality, it may be difficult to sense the voltage of the battery cell 10, which may cause a defect in the battery module.

In addition, if the position of the sensing terminal 320 is misaligned and interferes with a welding region between the electrode lead and the bus bar 100, a welding defect in the electrode lead may occur, which may lead to a serious defect in the battery module.

Therefore, the present disclosure proposes a battery module capable of efficiently controlling the position of the sensing terminal 320 during the coupling process between the sensing terminal 320 and the bus bar 100.

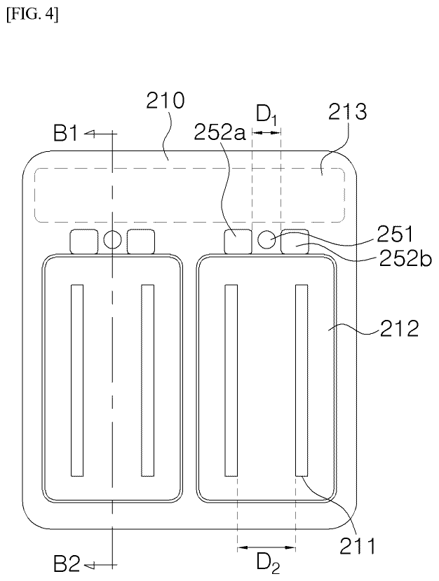

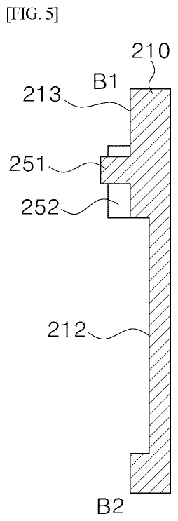

FIG. 4 is a front view schematically illustrating the bus bar frame 200 according to an embodiment of the present disclosure, and FIG. 5 is a cross-sectional view taken along line B1-B2 of FIG. 4.

Referring to FIGS. 4 and 5, the bus bar frame 200 according to an embodiment of the present disclosure may include a frame body 210 and the terminal restraining part 250.

The frame body 210 may be disposed at the front of the cell stack 1 so that the electrode leads of each battery cell 10 pass through. The frame body 210 may include a frame slot 211 formed therein, through which the electrode leads may pass. The frame body 210 may be disposed so as to cover at least a portion of one side of the cell stack 1. For example, the frame body 210 may be provided in the form of a plate having a predetermined area, but it is not limited thereto.

In one embodiment, the frame body 210 may include a bus bar seating part 212 formed on the front surface thereof, on which the bus bar 100 is seated. For example, the bus bar seating part 212 may be formed in a lower region of the front surface of the frame body 210. For example, the bus bar seating part 212 may be formed concavely to accommodate the bus bar 100 on the front surface of the frame body 210. For example, the bus bar seating part 212 may be formed concavely to have a depth corresponding to the thickness of the bus bar 100.

The bus bar 100 electrically connecting each of the plurality of battery cells 10 may be disposed in the frame body 210. For example, the bus bar 100 may be disposed on the front surface of the frame body 210. For example, the bus bar 100 may be disposed in the lower region of the front surface of the frame body 210. For example, the bus bar 100 may be inserted into and disposed in the bus bar seating part 212 of the frame body 210. The bus bar 100 may be disposed such that the bus bar slot 110 and the frame slot 211 communicate with each other.

The sensing module 310 may be disposed on the front surface of the frame body 210. For example, the sensing module 310 may be disposed in the sensing module seating part 213 formed in an upper region of the front surface of the frame body 210. For example, the sensing module 310 may be disposed on the front surface of the frame body 210 to extend in the stacking direction. For example, the sensing module 310 may be disposed in the upper region of the front surface of the frame body 210 so as to be spaced apart from the bus bar 100.

The sensing terminal 320 may be disposed on the front surface of the frame body 210 so that the sensing module 310 and the bus bar 100 are electrically connected. At this time, the sensing terminal 320 may include a bus bar coupling region 3203 in which at least a partial region overlaps with the bus bar 100.

Meanwhile, the terminal restraining part 250 may be disposed on the front surface of the frame body 210 to protrude in the longitudinal direction of the battery cell 10 and support the sensing terminal 320.

The terminal restraining part 250 may protrude forward from the front surface of the frame body 210. The terminal restraining part 250 may support the sensing terminal 320 in a region excluding the bus bar coupling region 3203 of the sensing terminal 320, thereby restraining the position of the sensing terminal 320.

In one embodiment, the terminal restraining part 250 may include the first restraining part 251 and a second restraining part 252. The first restraining part 251 and the second restraining part 252 of the terminal restraining part 250 may be in contact with different regions of the sensing terminal 320 to restrict the positional movement of the sensing terminal 320.

For example, the first restraining part 251 and the second restraining part 252 may protrude by a length greater than a thickness of the sensing terminal 320 from the frame body 210.

For example, the first restraining part 251 and the second restraining part 252 may be disposed to support the sensing terminal 320 at different heights in the vertical direction. For example, the first restraining part 251 may be disposed to support the sensing terminal 320 at a position higher than the second restraining part 252. In the present disclosure, due to the flexibility of the sensing terminal 320, there is a risk that a portion below the through-hole 3202 may rotate while the sensing terminal 320 is primarily supported by the first restraining part 251. However, since the second restraining part 252, which supports a side surface of the sensing terminal 320, is disposed to support a lower portion than the first restraining part 251, the rotation of the sensing terminal 320 may be more reliably prevented.

However, this is merely illustrative, and the second restraining part 252 may be disposed to support the sensing terminal 320 at the same height as the first restraining part 251. Alternatively, the second restraining part 252 may be disposed to support the sensing terminal 320 at a position higher than the first restraining part 251.

First, the terminal restraining part 250 may include the first restraining part 251 that protrudes forward from the front surface of the frame body 210. The first restraining part 251 may be disposed to pass through the through-hole 3202 of the sensing terminal 320, thereby restricting the translational movement of the sensing terminal 320 in the vertical direction or the stacking direction.

The first restraining part 251 may be disposed to protrude from the frame body 210 and pass through the sensing terminal 320 in the longitudinal direction of the battery cell 10. At least a partial region of the first restraining part 251 may be in contact with an inner circumferential surface of the through-hole 3202 of the sensing terminal 320.

The first restraining part 251 may be disposed to protrude in a columnar shape from the front surface of the frame body 210. For example, the first restraining part 251 may be formed in a cylindrical shape with a central axis parallel to the longitudinal direction of the battery cell 10, but it is not limited thereto.

the protrusion length of the first restraining part 251 from the front surface of the frame body 210 may be greater than that of the second restraining part 252 from the frame body 210, as described below.

The first restraining part 251 may be disposed between the bus bar slots 110 that are arranged adjacent to each other on the bus bar 100. The first restraining part 251 may be inserted into the through-hole 3202 of the sensing terminal 320, thereby restricting the positional movement of the sensing terminal 320 so that the sensing terminal 320 does not interfere with the electrode lead drawn through the bus bar slots 110.

In one embodiment, the first restraining part 251 may include a shaft portion 2512 extending from the front surface of the frame body 210 and a head portion 2511 formed at an end of the shaft portion 2512. At least a partial region of the shaft portion 2512 may be in contact with the inner circumferential surface of the through-hole 3202 of the sensing terminal 320 to restrict the positional movement of the lower end of the sensing terminal 320 in the forward direction.

The head portion 2511 may be formed so that its cross-sectional area decreases with increasing distance from the frame body 210. The head portion 2511 may guide the first restraining part 251 for easy insertion into the through-hole 3202 of the sensing terminal 320.

The terminal restraining part 250 may include the second restraining part 252, at least a partial region of which is in contact with the side surface of the sensing terminal 320 to restrict the positional movement of the sensing terminal 320.

A pair of second restraining parts 252a and 252b may be disposed on opposite sides of the sensing terminal 320 in the stacking direction. The pair of second restraining parts 252a and 252b may be in contact with the opposite sides of the sensing terminal 320, respectively. The second restraining parts 252 may include tapered portions 2525 formed on inner side surfaces thereof, which are in contact with the side surfaces of the sensing terminal 320, such that at least a partial region is tapered to guide the sensing terminal 320 to easily enter between the pair of second restraining parts 252a and 252b.

A gap (e.g., D1 of FIG. 4) between the pair of second restraining parts 252a and 252b may be formed smaller than a gap (e.g., D2 of FIG. 4) between the bus bar slots 110 that are arranged adjacent to each other in the bus bar 100. Therefore, in the battery module of the present disclosure, even if the sensing terminal 320 rotates during the assembly process of the sensing terminal 320, excessive positional movement may be restricted by contact with the second restraining part 252. Therefore, in the battery module of the present disclosure, since the rotation of the sensing terminal 320 is restricted by the second restraining part 252, the sensing terminal 320 may be prevented from interfering with the electrode lead drawn through the bus bar slot 110.

Meanwhile, the second restraining part 252 may be disposed so that at least a partial region thereof supports the bus bar 100. At least one of the pair of second restraining parts 252a and 252b may be disposed to be in contact with the bus bar 100. In the present disclosure, the positional movement of the bus bar 100 may be restricted by the second restraining parts 252. Accordingly, in the process of positioning the bus bar 100 in the frame body 210, the frame slot 211 of the frame body 210 and the bus bar slot 110 of the bus bar 100 may be easily aligned.

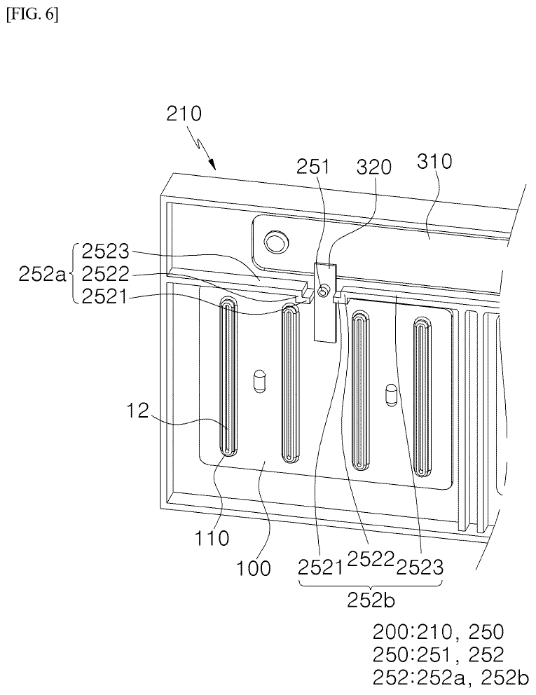

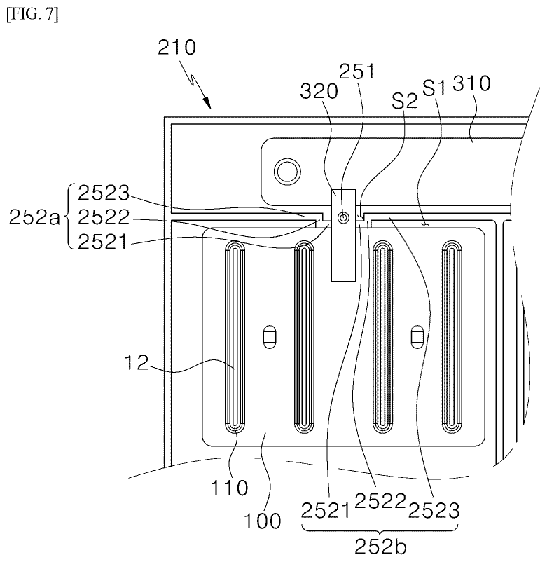

FIG. 6 is a perspective view schematically illustrating an assembly structure of the sensing terminal 320 according to an embodiment of the present disclosure, and FIG. 7 is a front view schematically illustrating the assembly structure of the sensing terminal 320 according to an embodiment of the present disclosure.

Referring to FIGS. 6 and 7, in this embodiment, a second restraining part 252 may be provided in the form of a rib disposed on opposite sides of the sensing terminal 320. For example, the second restraining part 252 may include a support portion 2521 disposed at a first height in the vertical direction such that one end thereof is in contact with the side surface of the sensing terminal 320, a base portion 2523 disposed at a second height such that one end thereof is spaced apart from the side surface of the sensing terminal 320, and a vertical extension portion 2522 configured to connect one end of the base portion 2523 and the other end of the support portion 2521.

The support portion 2521 may be disposed on the front surface of the frame body 210 at the first height in the vertical direction. For example, the first height may be an arbitrary position that is higher than the bus bar coupling region 3203 of the sensing terminal 320. For example, the first height may be an arbitrary position that is higher than the bus bar coupling region 3203 of the sensing terminal 320 and lower than the first restraining part 251.

An inner side surface of one end of the support portion 2521 may be in contact with the side surface of the sensing terminal 320 to restrict the rotation of the sensing terminal 320. In addition, a lower surface of one end of the support portion 2521 may be in contact with the upper surface of the bus bar 100 to further restrict the vertical positional movement of the bus bar 100.

Meanwhile, the base portion 2523 may be disposed on the front surface of the frame body 210 to extend in the stacking direction at the second height in the vertical direction. For example, the second height may be an arbitrary position higher than the first height at which the support portion 2521 is disposed. For example, the second height may be at least the same height as the height of the first restraining part 251.

A lower surface of the base portion 2523 may be disposed to be spaced apart from the upper surface of the bus bar 100 by a predetermined distance. Accordingly, a first spaced gap (e.g., S1 of FIG. 7) may be formed between the base portion 2523 and the bus bar 100. In the battery module of the present disclosure, the base portion 2523 may be disposed to be spaced apart from the upper surface of the bus bar 100, thereby minimizing interference between the bus bar 100 and the second restraining part 252 during placement of the bus bar 100 on the front surface of the frame body 210.

A gap between the pair of base portions 2523 arranged adjacent to each other is greater than a width of the sensing terminal 320.

The second restraining part 252 may include the vertical extension portion 2522 that connects the support portion 2521 and the base portion 2523, which are disposed at different heights. The vertical extension portion 2522 may be disposed to connect the other end of the support portion 2521 and one end of the base portion 2523. At this time, since one end of the base portion 2523 is spaced apart from the side surface of the sensing terminal 320, the vertical extension portion 2522 extending from one end of the base portion 2523 may also be spaced apart from the side surface of the sensing terminal 320. Accordingly, the battery module of the present disclosure may include a second spaced gap (e.g., S2 of FIG. 7) formed between the inner side surface of the vertical extension portion 2522 and the side surface of the sensing terminal 320. The battery module of the present disclosure may minimize interference between the sensing terminal 320 and the second restraining part 252 during placement of the sensing terminal 320 on the front surface of the frame body 210.

In the above, for convenience of description, the components of the battery module, such as the bus bar 100, the bus bar frame 200, the sensing restraining part, and the sensing terminal 320, have been described based on one electrode lead (e.g., the first electrode lead) drawn out to the front of the cell stack 1, but it should be understood that the same components may be disposed in the direction in which the other electrode lead (e.g., the second electrode lead) is drawn out (e.g., to the rear of the cell stack 1).

Meanwhile, each electrode lead of the plurality of battery cells 10 of the battery module may be drawn out to the front by passing through the bus bar slot 110.

Meanwhile, in the battery module of the present disclosure, since the sensing terminal 320 is coupled to the front surface of the frame body 210 with its positional movement restricted by the above-described first restraining part 251 and the second restraining part 252, the bus bar coupling region 3203 of the sensing terminal 320 may be stably formed between adjacent electrode leads. Therefore, the present disclosure may improve the welding quality between the sensing terminal 320 and the bus bar 100, and prevent the sensing terminal 320 from being detached from the bus bar 100 as a result of poor welding.

In addition, the battery module of the present disclosure may prevent interference between the sensing terminal 320 and the electrode lead, thereby enabling reliable welding of the electrode lead and the bus bar 100.

In the above, although the embodiments of the present disclosure have been described with all components coupled in one or operating in combination, the present disclosure is not necessarily limited to such embodiments. Within the scope of the purpose of the present disclosure, all components may be selectively coupled in one or more and operate accordingly. Unless otherwise defined, all terms including technical or scientific terms have the same meanings as commonly understood by those skilled in the art to which the present disclosure pertains. Commonly used terms, such as those defined in dictionaries, should be interpreted in accordance with the contextual meaning in the relevant technical field, and unless explicitly defined in the present disclosure, shall not be interpreted in an idealized or unduly formal sense.

The above description is merely illustrative of the technical spirit of the present disclosure, and it will be appreciated by those skilled in the art to which the present disclosure pertains that various modifications and alterations can be made without departing from the essential characteristics of the present disclosure. Therefore, the embodiments disclosed herein are intended to describe, not to limit, the technical spirit of the present disclosure, and the scope of the technical spirit is not limited to these embodiments. The scope of protection of the present disclosure shall be defined by the following claims, and all technical spirits that fall within the equivalent scope shall be construed as being included within the scope of the present disclosure.

What is claimed is:

1. A battery module comprising:
a cell stack in which a plurality of battery cells are stacked;
a bus bar frame disposed on one side of the cell stack;
a bus bar disposed on the bus bar frame and configured to electrically connect each of the plurality of battery cells; and
a sensing terminal disposed on the bus bar frame and electrically connected to the bus bar,
wherein a terminal restraining part is disposed on a front surface of the bus bar frame, the terminal restraining part protruding forward and supporting at least a partial region of the sensing terminal.

2. The battery module according to claim 1, wherein the terminal restraining part comprises a first restraining part disposed to pass through the sensing terminal and restrict a positional movement of the sensing terminal.

3. The battery module according to claim 2, wherein the first restraining part protrudes from the frame body and is disposed to pass through the sensing terminal in a longitudinal direction of the battery cell.

4. The battery module according to claim 2, wherein the first restraining part is formed in a cylindrical shape.

5. The battery module according to claim 2, wherein the first restraining part comprises a shaft portion extending from the frame body and a head portion formed at an end of the shaft portion,
wherein the head portion has a cross-sectional area that decreases with increasing distance from the frame body.

6. The battery module according to claim 2, wherein the sensing terminal comprises a through-hole formed on one side thereof, through which the first restraining part passes.

7. The battery module according to claim 2, wherein the terminal restraining part comprises a second restraining part, at least a partial region of which is in contact with a side surface of the sensing terminal to restrict the positional movement of the sensing terminal.

8. The battery module according to claim 7, wherein a pair of second restraining parts are provided so as to be in contact with opposite sides of the sensing terminal, respectively.

9. The battery module according to claim 7, wherein the second restraining parts are disposed so that at least a partial region thereof is in contact with the bus bar.

10. The battery module according to claim 8, wherein each of the pair of second restraining parts comprises:
a support portion disposed at a first height such that one end thereof is in contact with the side surface of the sensing terminal;
a base portion disposed at a second height such that one end thereof is spaced apart from the side surface of the sensing terminal; and
a vertical extension portion configured to connect one end of the base portion and the other end of the support portion.

11. The battery module according to claim 10, wherein a gap between the pair of base portions arranged adjacent to each other is greater than a width of the sensing terminal.

12. The battery module according to claim 10, wherein the first restraining part is disposed higher than the support portion.

13. The battery module according to claim 10, wherein the base portion is disposed to be spaced apart from the bus bar by a predetermined distance.

14. The battery module according to claim 7, wherein the first restraining part and the second restraining part support the sensing terminal at different heights.

15. The battery module according to claim 14, wherein the first restraining part supports the sensing terminal at a position higher than the second restraining part.

16. The battery module according to claim 7, wherein the protrusion length of the first restraining part from the frame body is greater than that of the second restraining part from the frame body.

17. The battery module according to claim 7, wherein the first restraining part and the second restraining part protrude from the frame body by a length greater than a thickness of the sensing terminal.

18. The battery module according to claim 1, wherein the sensing terminal comprises a bus bar coupling region in which at least a partial region of the sensing terminal overlaps the bus bar, and
the terminal restraining part is disposed to support the sensing terminal in a region excluding the bus bar coupling region.

19. The battery module according to claim 2, wherein the bus bar comprises a bus bar slot formed to allow electrode leads of the battery cell to be drawn out, and
the first restraining part is disposed between the bus bar slots arranged adjacent to each other.

20. The battery module according to claim 19, wherein a gap between a pair of the second restraining parts is formed smaller than a gap between the slots arranged adjacent to each other.
